(19) United States
(12) Patent Application Publication
(10) Pub. No.: US 2015/0012377 A1
(43) Pub. Date: Jan. 8, 2015

(54) SYSTEMS AND METHODS FOR COMPARATIVELY DISPLAYING DISPARATE SERVICE OFFERINGS

(71) Applicant: Client Relationships Distribution LLC, St. Louis, MO (US)

(72) Inventors: Tom Koby, O'Fallon, MO (US); Alan Lerner, Phoenix, AZ (US)

(21) Appl. No.: 14/310,990

(22) Filed: Jun. 20, 2014

Related U.S. Application Data
(60) Provisional application No. 61/837,731, filed on Jun. 21, 2013.

(51) Int. Cl. G06Q 30/06; G06Q 30/02

(52) U.S. Cl. CPC G06Q 30/0611; G06Q 30/0282
USPC 705/26.4

(57) ABSTRACT

Systems and methods for providing instant, real-time quotes for mixed product/service solutions, such as home improvement products, and allowing for fair price comparisons.

### CROSS REFERENCE TO RELATED APPLICATION(S)

This application claims benefit of U.S. Provisional Patent Application No. 61/837,731 filed Jun. 21, 2013, the entire disclosure of which is incorporated herein by reference.

### BACKGROUND

1. Field of the Invention

This disclosure relates to the field of quoting and, specifically to providing comparison quoting for dissimilarly priced-mixed offerings of labor and materials.

2. Description of the Related Art

Getting quotes and estimates for certain types of products and services is difficult and time-consuming. This is particularly true where products and services are sold together, such as home improvement projects. The difficulty is in part because service providers and customers both suffer from a lack of complete information. Customers do not know provider material or labor costs, and providers do not know the details of the customer project. The bidding/estimate process fills this gap for the supplier, who physically visits the work site to take measurements, ask questions, and gather the information needed for the supplier to complete the bid.

However, this does not solve the information disparity for the customer, who often has only the final bid number, devoid of detail on the calculations that comprise it. This makes comparing that bid with another contractor's bid difficult. Even where the customer has enough detail to compare bids, non-trivial calculations may be necessary to compare the bids on an equal basis. Further, where there are major gaps between two suppliers, the customer lacks information about service quality, which could explain pricing disparities. For example, do bids differ because one provider does better work (and charges more), or is a supplier more expensive because he pays more for materials?

The bidding process presents other difficulties as well. Estimates typically require measurements and different suppliers may measure differently. For example, where a homeowner wishes to have hardwood flooring installed in a kitchen, one supplier may measure to the kick plate of existing counters, whereas another measures to the walls. This adds to the difficulty in comparing bids.

Getting multiple bids also means multiple installers physically visit the location and take measurements, resulting in needless rework and wasted time. Moreover, many providers take the opportunity to engage in high-pressure on-the-spot sales pitches, asking about other bids in an attempt to win the job on the spot before the consumer can think through options, or comparison shop.

Further complicating things, the costs of materials and labor can vary wildly. This is not only because of quality differences, but differences in provider price models. One installer may pay $25.00 per square foot for a material that costs another installer only $19.00. Where these prices are not included in the bid detail, the customer has no way of knowing whether a provider is buying the materials cheaper and pocketing the difference instead of passing the savings on to the customer. Likewise, one provider may appear substantially less expensive because that provider's quote does not include features assumed in another provider's bid. For example, one flooring installer may charge a lower per-square foot rate for labor, but exclude thresholds or cutouts, which are additional charges.

Providers also do not price their services in uniform fashion. For example, some charge a flat per-unit rate inclusive of labor and materials, whereas others break out material separately. For example, one service provider may charge $75 per square foot of countertop installed inclusive of the material cost. Such flat-rate pricing is generally limited to a certain tier or quality of material, limiting the customer's options. However, another installer may charge only $50 per square foot, but require the customer to pay actual costs for material, including waste, which the customer is generally not qualified to estimate.

Further complicating this landscape, material suppliers sometimes sell products only through specific distribution chains, or sign exclusivity agreements limiting availability for their products to certain service providers. For example, the supplier for a particularly fashionable granite countertop pattern may enter into an exclusive deal with one specific home improvement store, by which only subcontractors for the home improvement store can install that specific granite. This makes it virtually impossible for customers to simply pick a material that will work in their homes, and then get a list of installers who can use it. Instead, customers must search a number of stores, or providers, to find a desirable material. Ultimately, consumers are sometimes left to choose between an installer who is more expensive but has the specific material the consumer wants, versus an installer who is cheaper but does not. Faced with the prospect of sitting through hours of measurements and sales pitches, many consumers get only a handful of bids (sometimes only one) before giving up and simply picking the least unappetizing option.

Other common problems complicate bidding even further. For example, laying floor tile on the diagonal is generally more attractive, but also requires more cutting. Providers may charge an additional labor rate on a per-square foot basis for this feature, whereas others simply add a flat service charge. Likewise, some suppliers charge extra for working with multiple materials, or materials that require specialized equipment. Others charge more for special features, like upgraded countertop edging.

Existing bidding software merely assists an individual provider with preparing a bid, but does not provide for apples-to-apples comparisons between providers. This is in part because there is so much variance between material costs, labor costs, business models, and pricing metrics used by contractors and suppliers. Even if the customer is able to select the best bid, there remains the issue of managing contracts, change orders, and invoices, and scheduling delivery and installation, which can take days or weeks (sometimes months), and delivery time is not always precisely known in advance. Providers are generally reluctant to schedule installation until they know materials will be available.

Further, while there exist web sites for rating service providers, such as Angie's List™ they do not allow for side-by-side comparisons of provider quality in the context of a quote or bid for a specific project. These crowd-sourced reviewing sites simply compare quality among providers without reference to the scope and extent of the proposed job. Thus, a user cannot, for example, get a side-by-side comparison quote between two providers in addition to review aggregation to add context to the data. That is, where two providers differ wildly in price for the same job, there is currently no way to assess or determine whether or to what extent that difference may be a function of service quality and/or professionalism.

At the end of the day, it is all but impossible for a customer to get a simple apples-to-apples comparison between two contractors for the same job, and the bidding process generally results in a great deal of lost time and inefficiency, not only for the customer, but also for the installers, who are constantly called out to take redundant measurements.

### SUMMARY

The following is a summary of the invention, which should provide to the reader a basic understanding of some aspects of the invention. This summary is not intended to identify critical components of the invention, nor in any way to delineate the scope of the invention. The sole purpose of this summary is to present in simplified language some aspects of the invention as a prelude to the more detailed description presented below.

Because of these and other problems in the art, described herein, among other things, is a method for comparatively displaying quotes comprising: providing a database; providing a quote server communicatively connected to a client device over a network, the quote server comprising a microprocessor and a non-volatile computer-readable medium having computer readable instructions stored thereon, the computer-readable instructions comprising a quote module; storing normalized quote metric data in the database; the quote server receiving from the client device over the network a customer project criteria dataset comprising at least one measurement of a dimension for a home improvement project and an indication of at least one material to be used in a home improvement project, the amount of the material to be used in the home improvement project being based at least in part on the at least one measurement of a dimension; the quote module selecting from the stored normalized quote metric a search result dataset, the selection of the search result database being based at least in part on the received customer project criteria dataset and comprising data indicative of a plurality of service providers, each service provider in the plurality of service providers being associated in the stored normalized quote metric data with the material; for each one of the service providers in the plurality of service providers, the quote module calculating a bid estimate for the service provider to install the material in the home improvement project, the calculated bid estimate being based at least in part on a cost of the material indicated in the stored normalized dataset for the service provider, and the calculated bid estimate being based at least in part on the measurement of a dimension received by the quote server; the quote server transmitting data to the client device, the transmitted data causing to be displayed on the client device, for each one of the service providers in the plurality of service providers, an identification of the service provider indicated in the stored normalized dataset and the calculated bid estimate for the service provider.

In an embodiment of the method, the quote metric data is selected from the group consisting of: material data, feature data, supplier data, service provider data, and group data. In another embodiment of the method, the client device is selected from the group consisting of: a smart phone, a tablet computer, a desktop computer, a laptop computer, an e-reader, and a kiosk.

In another embodiment of the method, the calculated bid estimate comprises a labor cost, a material cost, and a feature cost.

In another embodiment of the method, for each service provider in the plurality of service providers, the selected search result data comprises review and rating data about the service provider.

In another embodiment of the method, the transmitted data to the client device further causes to be displayed on the client device, for each one of the service providers in the plurality of service providers, a visualization of the search result data about the service provider.

Also described herein, among other things, is a system for transmitting service provider quotes comprising: a database stored on a non-volatile computer-readable storage medium, the database comprising normalized quote metric data; a computer server communicating over a network, the server comprising a microprocessor and a non-volatile computer-readable storage medium having stored thereon computer-readable program instructions which, when executed by the microprocessor, cause the microprocessor to cause to be transmitted from the computer server to a client device communicatively connected to the server over the network a service provider dataset comprising a plurality of service provider datasets, the service provider dataset based at least in part upon normalized quote metric data selected from the database by the computer server, and the selected normalized quote metric data being selected at least in part based on customer project criteria data received by the server from the client device over the network.

In an embodiment of the system, at least some of the normalized quote metric data in the database is selected from the group consisting of: material data, feature data, supplier data, service provider data, and group data.

In another embodiment of the system, the client device is selected from the group consisting of: a smart phone, a tablet computer, a desktop computer, a laptop computer, an e-reader, and a kiosk.

In another embodiment of the system, for each service provider dataset in the plurality of service provider datasets, the service provider dataset further comprises a programmatically calculated bid estimate for the service provider to perform a scope of services indicated by the customer project criteria received by the server.

In another embodiment of the system, for each service provider dataset in the plurality of service provider datasets, the service provider dataset further comprises a review and rating data about the service provider.

In another embodiment of the system, the review and rating data about the service provider is based at least in part on reviews and ratings about the service provider previously submitted by customers of the service provider.

Also described herein, among other things, is a kiosk comprising: a kiosk frame; a display; a manual user interface; a client computer comprising a microprocessor and a non-volatile computer-readable memory having stored thereon computer-readable instructions which, when executed by the microprocessor, cause the client computer to: display on the display a graphical user interface comprising a form for submitting customer project criteria data; in response to a user submitting customer project criteria data using the form, transmit the customer project criteria data to a quote server and to request from the quote server one or more estimates for the cost of a service provider to complete the project described by the customer project criteria data; in response to receiving from the quote server the one or more estimates, displaying on the display an identification of the service provider and the amount of the estimate.

### BRIEF DESCRIPTION OF THE DRAWINGS

FIG. 1 depicts a high-level flow chart of an embodiment of the systems and methods.

FIG. 2 depicts a schematic flow chart of an embodiment of the systems and methods.

FIG. 3 depicts a schematic diagram of hardware implementing an embodiment of the systems and methods.

FIG. 4 depicts an alternative schematic diagram of hardware implementing an embodiment of the systems and methods.

FIG. 5 depicts an embodiment of a screen for inputting customer criteria and/or data.

FIG. 6 depicts an embodiment of a screen for comparatively displaying bids or quotes.

FIGS. 7A through 71 depict embodiments of screens for providing quote metric data.

### DESCRIPTION OF THE PREFERRED EMBODIMENT(S)

The following detailed description and disclosure illustrates by way of example and not by way of limitation. This description will clearly enable one skilled in the art to make and use the disclosed systems and methods, and describes several embodiments, adaptations, variations, alternatives and uses of the disclosed systems and apparatus. As various changes could be made in the above constructions without departing from the scope of the disclosures, it is intended that all matter contained in the above description or shown in the accompanying drawings shall be interpreted as illustrative and not in a limiting sense.

Throughout this disclosure, the term “computer” generally refers to hardware which generally implements functionality provided by digital computing technology, particularly computing functionality associated with processors and microprocessors. The term “computer” is not intended to be limited to any specific type of computing device, but it is intended to be inclusive of all computational devices including, but not limited to: processing devices, microprocessors, personal computers, desktop computers, laptop computers, workstations, terminals, servers, clients, portable computers, handheld computers, smart phones, tablet computers, mobile devices, e-readers, wearable computers including but not limited to Google® Glass™, server farms, hardware appliances, minicomputers, and mainframe computers.

As used herein, a “computer” is necessarily an abstraction of the functionality provided by a single computer device outfitted with the hardware and accessories typical of computers in a particular role. By way of example and not limitation, the term “computer” in reference to a laptop computer would be understood by one of ordinary skill in the art to include the functionality provided by manually manipulable input devices, such as a mouse, track pad, or stylus, whereas the term “computer” used in reference to an enterprise-class server would be understood by one of ordinary skill in the art to include the functionality provided by redundant systems, such as RAID drives and dual power supplies.

It is also well known to those of ordinary skill in the art that the functionality of a single computer may be distributed across a number of individual machines. This distribution may be functional, as where specific machines perform specific tasks; or balanced, as where each machine is capable of performing most or all functions of any other machine and is assigned tasks based on its available resources at a point in time. Thus, the term “computer” as used herein, can refer to a single, standalone, self-contained device or to a plurality of machines working together or independently, including without limitation: a network server farm, “cloud” computing system, software-as-a-service, or other distributed or collaborative computer networks.

Those of ordinary skill in the art also appreciate that some devices which are not conventionally thought of as “computers” nevertheless exhibit the characteristics of a “computer” in certain contexts. Where such a device is performing the functions of a “computer” as described herein, the term “computer” includes such devices to that extent. Devices of this type include, but are not limited to, network hardware, print servers, file servers, NAS and SAN, load balancers, and any other hardware capable of interacting with the systems and methods described herein in the matter of a conventional “computer.”

Throughout this disclosure, the term “software” generally refers to code objects, program logic, command structures, data structures and definitions, source code, executable binary files, object code, compiled libraries, implementations, algorithms, or any instruction or set of instructions capable of being executed by a computer processor, or capable of being converted into a form capable of being executed by a computer processor, including, without limitation, virtual processors, or by the use of run-time environments or virtual machines. Those of ordinary skill in the art recognize that software can be wired directly onto hardware, including, without limitation, onto a microchip, and still be considered “software” within the meaning of this disclosure. For purposes of this disclosure, software includes, without limitation, instructions stored or storable in any form of memory device, including RAM, ROM, flash memory, BIOS, CMOS, mother and daughter board circuitry, hardware controllers, USB controllers or hosts, peripheral devices and controllers, video cards, audio controllers, network cards, Bluetooth® and other wireless communication devices, virtual memory, storage devices and associated controllers, firmware, and device drivers. The systems and methods described herein are contemplated to use computers and computer software typically stored in a non-transitory computer- or machine-readable media or memory.

Throughout this disclosure, terms used herein to describe or reference media, including, without limitation, terms such as “media,” “storage media,” and “memory,” generally refer to non-transitory computer-readable media, but may also include transitory media such as signals and carrier waves.

Throughout this disclosure, the term “network” generally refers to any data or telecommunications network over which computers communicate with each other. The term “server” generally refers to a computer providing a service over a network, and a “client” generally refers to a computer accessing or using a service provided by a server over a network. Those having ordinary skill in the art will appreciate the terms “server” and “client” may refer to hardware, software, and/or a combination of hardware and software, depending on context. Those having ordinary skill in the art will further appreciate that the terms “server” and “client” may refer to endpoints of a network communication or network connection, including but not necessarily limited to a network socket connection. Those having ordinary skill in the art will further appreciate that a “server” may comprise a plurality of software and/or hardware servers delivering a service or set of services. Those having ordinary skill in the art will further appreciate that the term “host” may, in noun form, refer to an endpoint of a network communication or network, or may, in verb form, refer to a server providing a service over a network, or an access point for a service over a network.

Throughout this disclosure, the terms “web,” “web site,” “web server,” “web client,” and “web browser” generally refer to computers programmed to communicate over a network using the HyperText Transfer Protocol (“HTTP”), and/or similar and/or related protocols including but not limited to HTTP Secure (“HTTPS”) and Secure Hypertext Transfer Protocol (“SHTP”). The term “web server” generally refers to a computer receiving and responding to HTTP requests, and a “web client” generally refers to a computer having a user agent sending and receiving responses to HTTP requests. The user agent is generally web browser software.

Throughout this disclosure, the term “real time” generally refers to software performance and/or response time within operational deadlines that are effectively generally cotemporaneous with a reference event in the ordinary user perception of the passage of time for a particular operational context. Those of ordinary skill in the art understand that “real time” does not necessarily mean a system performs or responds immediately or instantaneously. For example, those having ordinary skill in the art understand that, where the operational context is a graphical user interface, “real time” normally implies a response time of about one second of actual time for at least some manner of response from the system, with milliseconds or microseconds being preferable. However, those having ordinary skill in the art also understand that, under other operational contexts, a system operating in “real time” may exhibit delays longer than one second, such as where network operations are involved which may include multiple devices and/or additional processing on a particular device or between devices, or multiple point-to-point round-trips for data exchange among devices.

The explanations of terms provided herein should not be understood as limiting, but rather as examples of what certain terms used herein may mean to a person having ordinary skill in the applicable art. A person of ordinary skill in the art may interpret these terms as inherently encompassing and disclosing additional and further meaning not expressly set forth herein.

The systems and methods are described herein generally in reference to construction and home improvement. At a very high level, the systems and methods determine what data is required by service providers for residential home improvement products and services (generally referred to herein as “providers”) to provide quotes and bids to customers or potential customers, and collect that data from a plurality of such providers. The data collected is normalized and stored in a database. Customers submit queries to the system through a web site, and the received queries are used to find matching providers in the normalized data in the database. The matches are then comparably displayed to the customer, such that the customer can compare a plurality of quotes on an equal basis, along with aggregated reviews and/or ratings.

Although the present disclosure is generally described with respect to home improvement and residential structures, it is specifically contemplated that the systems and methods may be used in conjunction with other industries and applications, including commercial building improvement, and non-construction industries. The present disclosure is suitable for use in connection with any industry or application wherein quotes, bids, or estimates are customarily provided after a requirements- or data-gathering exercise, such as an inspection or customer meeting.

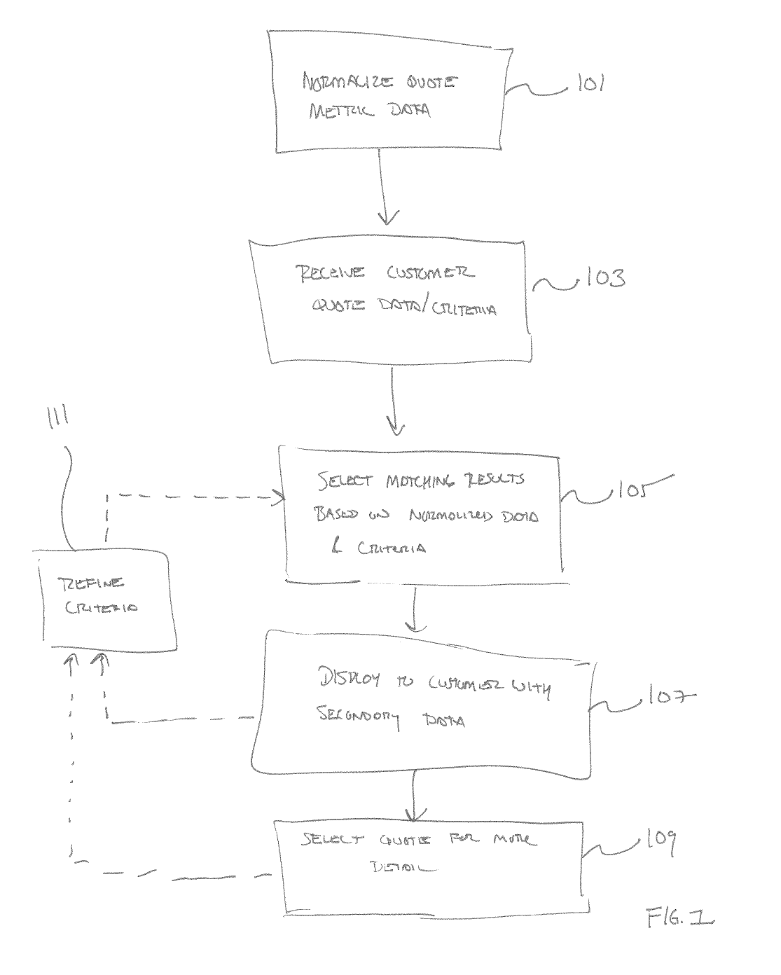

A high-level embodiment of the systems and methods described herein is depicted in FIG. 1. Generally speaking, the systems and methods comprise four elements, which are described in more detail elsewhere herein. First, quote metric data is collected and normalized (101), and generally stored, as normalized, in a database. Second, customer quote generation data and criteria (103) are received from a customer, who generally submits the data using a web site interface, and generally after quote metric data normalization (101). Third, matches are selected from the normalized quote metric data (105), generally based on the received customer quote generation data and criteria. Fourth, one or more matches are caused to be presented or displayed to the customer (107), generally in a comparison format allowing the customer to quickly assess the costs and scope of services offered by each matching bidder, as well as bidder quality. At various steps, the customer may refine search data or criteria (111) and resubmit the refined data or criteria to select (105) revised matches.

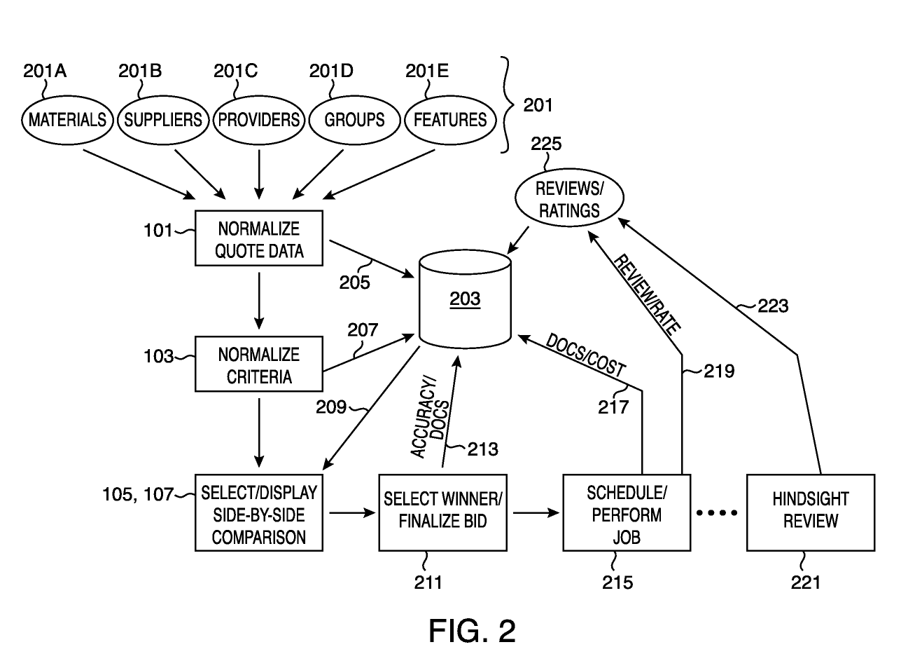

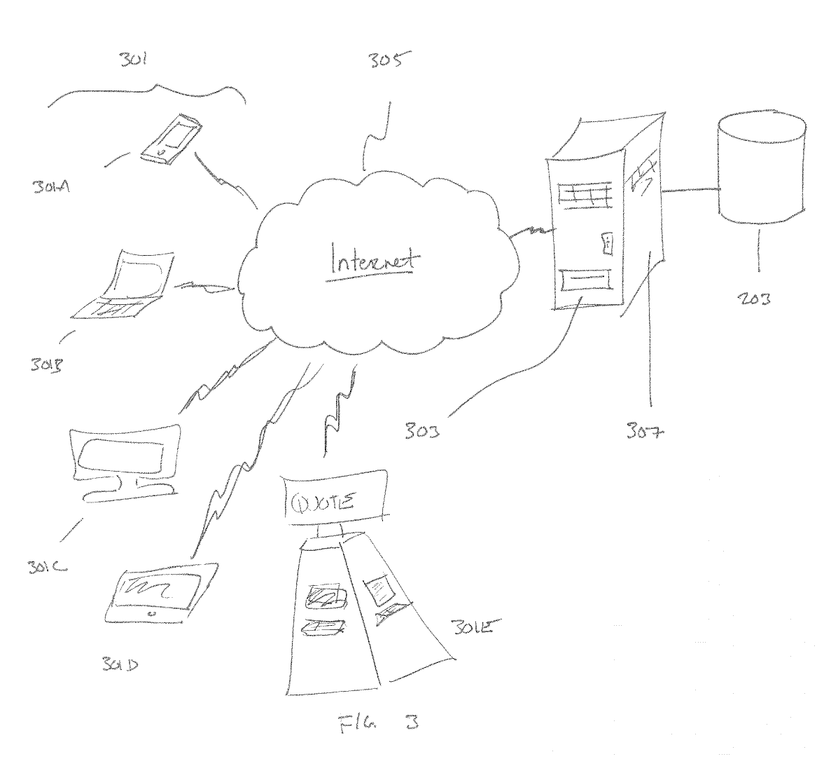

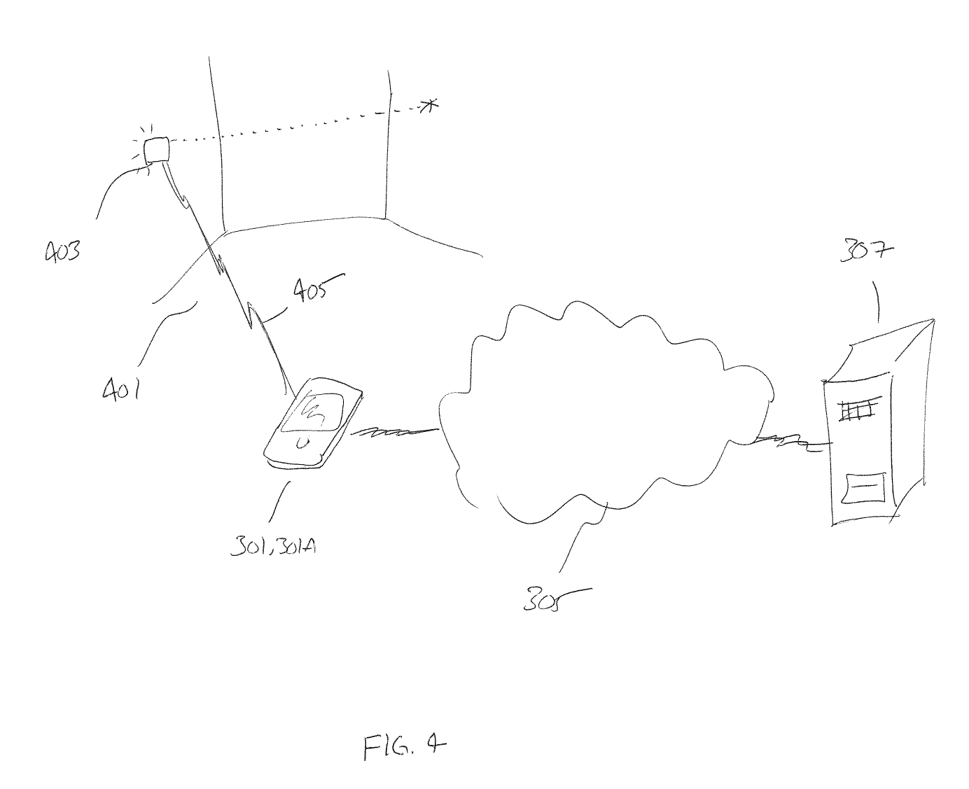

Although the systems and methods can be implemented without the use of computer technology, it is generally contemplated that computer technology will be used, due to the speed and accuracy of computer calculations, and the convenience of mobile computing. FIG. 2 depicts a schematic flow chart of one such computerized embodiment. In the depicted embodiment, quote metric data (201A, 201B, 201C, 201D, 201E) is provided and normalized (101). The depicted quote metric data comprises several categories of data particular to the home improvement industry. It will be understood by one of ordinary skill in the art that, for other industries or applications, other categories of quote metric data will apply.

The depicted quote metric data includes material data (201A). Materials are generally physical components that become a part of a building or structure when installed, or a “fixture” in legal parlance. Materials may be raw, intermediate, or finished goods. For example, for carpentry products, materials may be unsawn boards or dimensional lumber. Likewise, for a solid surface countertop, materials may be raw granite slabs or polished granite. Material data (201A) generally comprises, without limitation, the material type or category, the applicable measurement unit or units for the material, the name or title of a particular material, media files depicting the material, and tags. Generally, tags are searchable descriptive terms associated with the material, usually brief in nature, which can be searched to locate materials having certain characteristics. By way of example and not limitation, for a mottled granite pattern comprising gold and black inclusions, the tags may comprise “gold”, “black”, and “mottled.”

The depicted quote metric data includes material supplier data (201B). Material suppliers (herein, “suppliers”) are generally entities or individuals whose commercial function in the industry is to supply materials for use in projects. For example, in the depicted embodiment, a supplier may be a lumberyard supplying dimensional lumber (a material) to a carpenter (a provider). Supplier data (201B) generally comprises, without limitation, the supplier name, supplier type, one or more materials supplied by said supplier, the base cost of each such material, the supplier's margin on each such material, and the selling cost of each such material. Base cost may be a wholesale price. In an embodiment, material supplier data is associated with one or more materials and/or material data sets in the normalized database (203). Supplier type may refer, in an embodiment, to the type of material supplied. In an alternative embodiment, supplier type may be the type of supplier enterprise, such as a wholesale or retail supplier.

The depicted quote metric data includes feature data (201E). Features are generally services performed by providers with respect to a given type of project and/or material. By way of example and not limitation, features for countertop installation may comprise putting a particular type of edge (e.g., bullnose or ogee) on the facing edge of the countertop, or cutting holes for sinks, cooktops, power receptacles, and cord grommets. Also by way of example and not limitation, a feature for backsplash installation may be orienting tile on the diagonal or cutting out holes for power receptacles. In yet a further non-limiting example, features for flooring may be orienting wood on the diagonal, or cutting around ducting vents. Feature data (201F) generally comprises, without limitation, feature type, feature name and/or description, applicable measurement units, and order of appearance when presented to a user or displayed. Feature type generally may, in an embodiment, comprise the type of calculation performed to produce a quote or bid for a project including the feature. By way of example and not limitation, feature type may comprise cost-per-unit, a flat rate, or a threshold above which a charge applies.

The depicted quote metric data includes service provider data (201C). Providers are generally entities or individuals whose commercial function in the industry is to assemble and/or install materials and/or apply features. By way of example and not limitation, a provider may be a flooring installer, a countertop fabricator, a countertop installer, a drywall installer, a carpenter, a stonemason, a landscaper, a woodworker, a cabinet installer, and so forth. Generally, the provider physically visits the project site to perform manual and/or skilled labor. Provider data (201C) generally comprises, without limitation, the provider type, name, services offered, base cost/price for each such service, margin for each such service, selling cost/price for each such service, one or more materials supplied by said supplier, the base cost of each such material, the supplier's margin on each such material, and the selling cost of each such material. Provider data also generally comprises one or more features the provider can supply, costs for each such feature, and geographic data indicating the service area for the provider. Provider type may refer, in an embodiment, to the type of materials or projects. In an alternative embodiment, provider may comprise a type of business or business relationship. By way of example and not limitation, provider type may be a stocking provider, an exclusive provider, such as for a preferred material supplier, or a general provider.

The depicted quote metric data includes group data (201D). Groups are generally sets of providers, including related feature, supplier and material data, organized based upon some commonality. By way of example and not limitation, a group may comprise all hardwood flooring installers serving a given metropolitan area. Alternatively, and also by way of example and not limitation, a group may comprise all installers certified to install a particular type of product. Still further, a group may comprise all subcontractors authorized to perform contracts entered between customers and a big box retail chain. Providers, suppliers, materials, and features will generally aggregate for each particular group.

Particular quote metric data (201) may also be sometimes referred to as a “profile.” By way of example and not limitation, quote metric data for a material is sometimes known as a “material profile,” and quote metric data for a service provider is sometimes known as a “service provider profile.” The “profile” for a particular set of quote metric data generally refers to normalized data stored in a database.

This data (201) is generally normalized (101) and transmitted to and/or stored in (205) a database (203). The database will generally be a computerized relational database, such as Oracle®, MySQL™, PostgreSQL™, Microsoft® SQL Server, or functionally similar products. Normalization generally comprises reducing redundancy and duplication and providing uniformity in data quality and format to produce a searchable, canonical dataset. The database is generally communicatively accessible over a network. Normalization may comprise correcting errors, providing default values for missing or omitted data, and following up to clarify unclear, missing, or omitted data. Under some circumstances, however, missing data is expected and anticipated, as one feature of the systems and methods, described elsewhere herein, is that the systems and method can provide comparatively displayed bids on the basis of incomplete information.

Next, a customer seeking bids or estimates for a project supplies (103) customer quote data and/or criteria. Although this generally occurs after normalization, in an embodiment, data may be normalized (101) after the customer supplies (103) this data. Customer quote data and quote criteria may overlap, but may also comprise different sets of data. Customer quote data is generally data providers collect during a site visit to develop a quote, such as dimensions and features the customer wants or needs. Customer quote criteria are other data provided by the customer which may not necessarily be required to produce a quote, but may impact the bid amount or matches found. Such criteria may be subjective criteria, such as requiring certain colors of tile, or only providers who have at least 10 ratings in the system, or only providers whose average rating is above some minimum threshold, or only those providers whose estimates fall within a given dollar amount range.

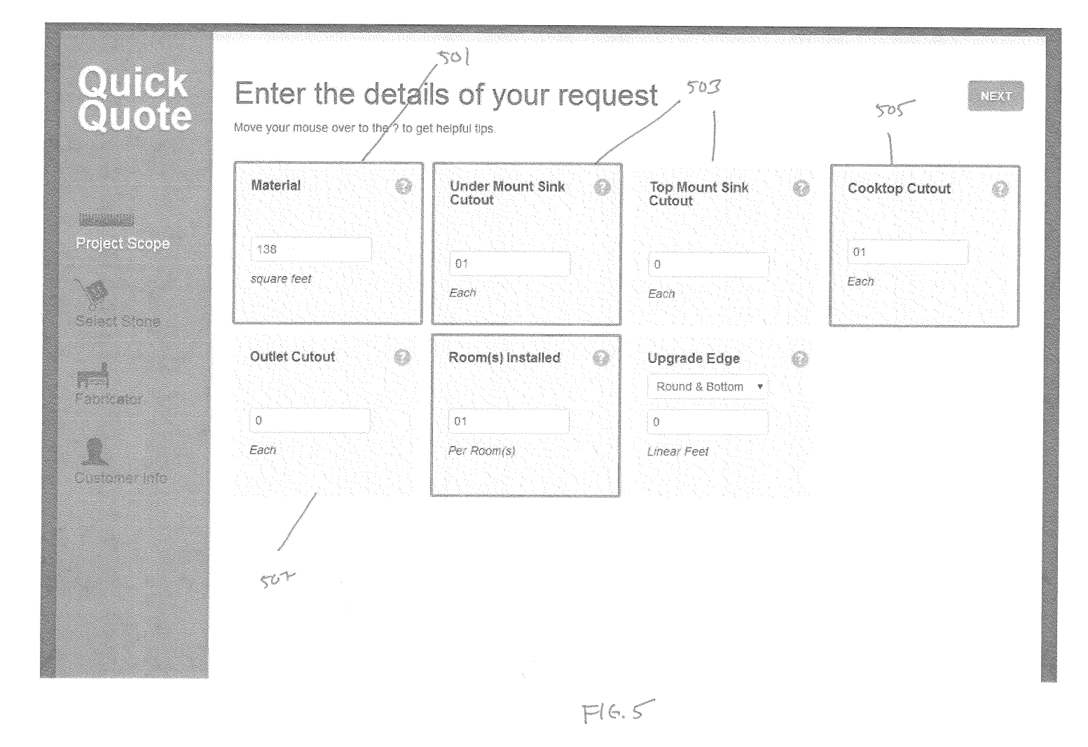

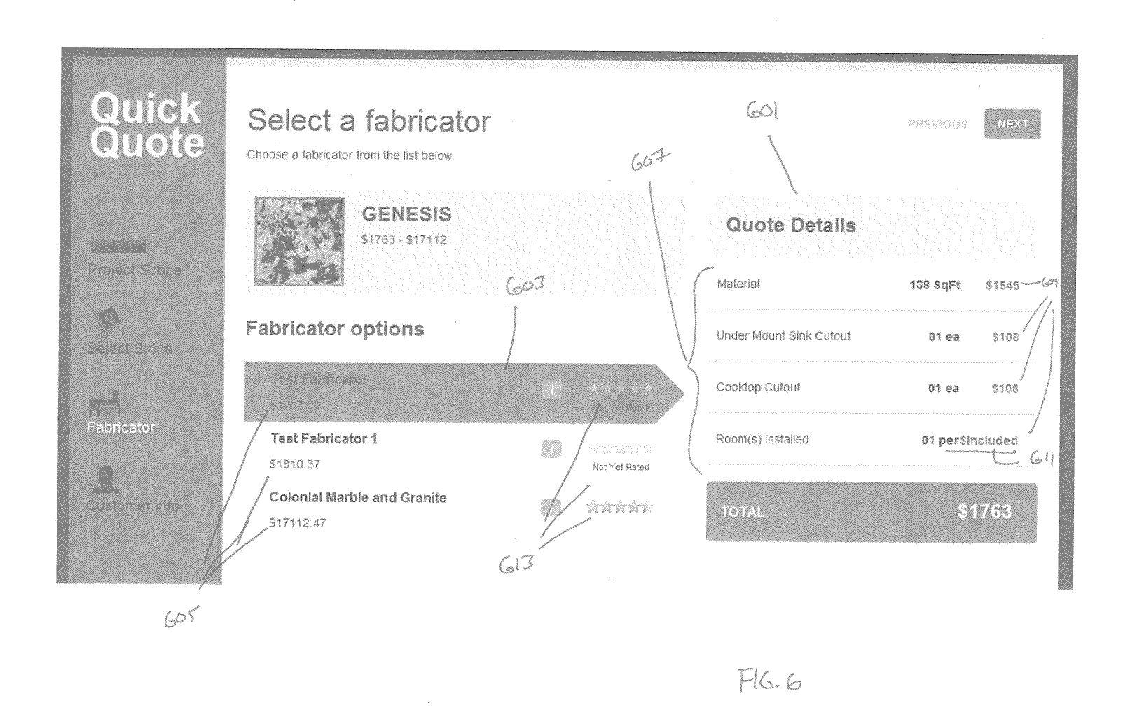

Customer quote data and criteria are generally provided by the customer manually inputting such data. In a simple embodiment, this may be by use of a hand-written form, but in the preferred embodiment, an electronic form is used. Such a form may be an interactive kiosk, a web site form, or an application submitting the data to a server over a network. Such an embodiment is depicted in FIG. 3. In the depicted embodiment of FIG. 3, the customer uses a client device (301) such as a smart phone (301A), laptop computer (301B), desktop computer (301C), tablet device (301D), kiosk (301E), or e-reader (not depicted), to input customer quote data and criteria. The data is received by a quote or bid server (303) over a network connection (305), said network generally comprising the Internet.

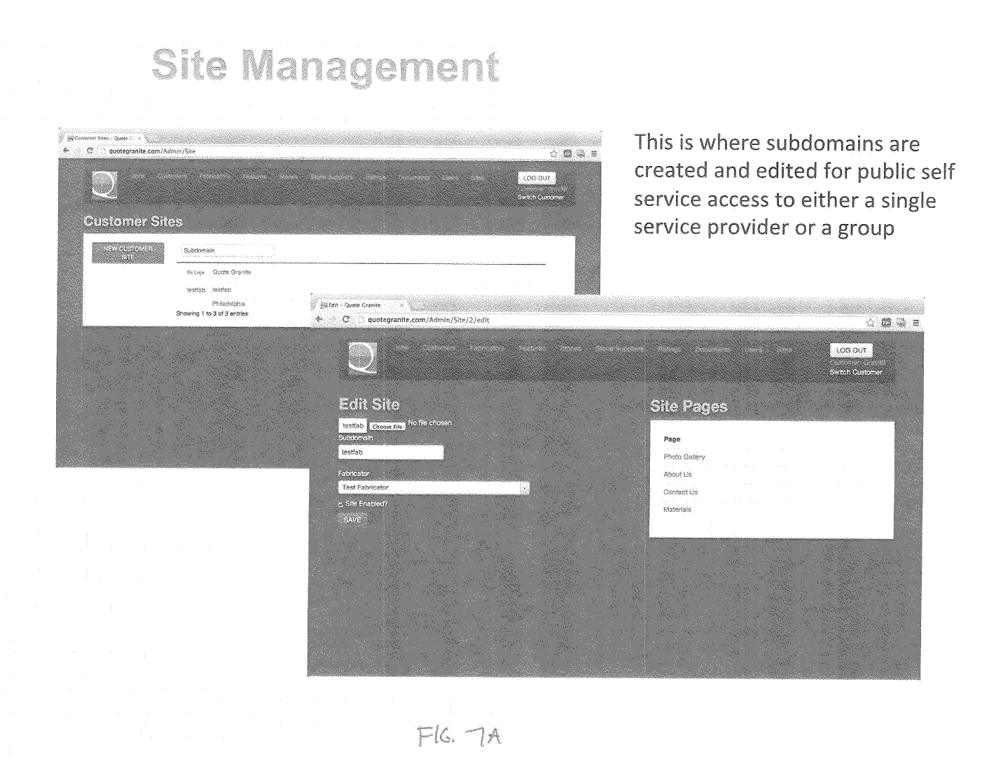

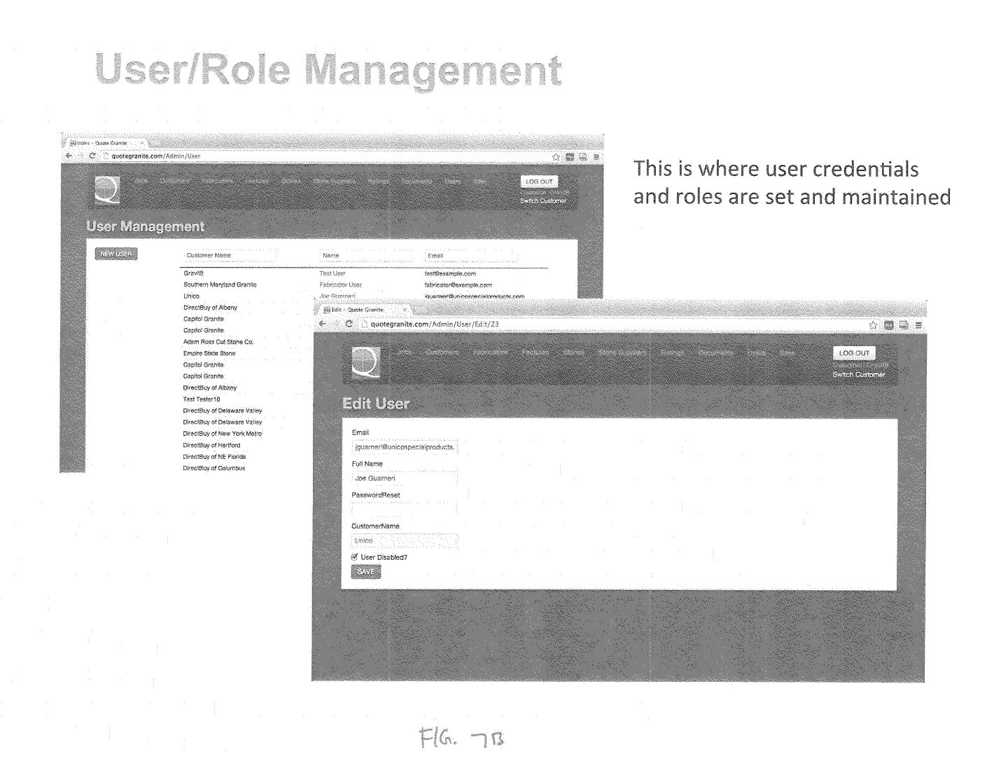

For improved accuracy and uniformity, the data may alternatively be provided using measurements from a measuring device. Such measurements may be wirelessly transmitted, as in the depicted embodiment of FIG. 4. Devices (403) are known in the art which can provide precise measurements using various technologies, such as lasers. It is specifically contemplated that such a device (403) could directly or indirectly provide measurement or other data. By way of example and not limitation, in the depicted embodiment of FIG. 4, a measuring device (403) placed in the work area (401) is used to measure a dimension of the area (401). The device is communicatively connected to a network-enabled device (301), such as a smart phone (301A), which is in turn communicatively connected to the bid server (303) over a network (305). Thus, the measurements taken by the measuring device (403) can be transmitted (405) to the smart phone (301A), which may in turn transmit the measurements to the bid server (303). This technique reduces human error and increases speed and efficiency.

In an alternative embodiment, the measuring device (403) may itself be communicatively connected to the bid/quote server (303), and may not require the use of an intervening network-enabled device (301). Similarly, in another alternative embodiment, the network-enabled device (301) may itself perform the measuring, such as by use of additional hardware or an inherent feature of the device (301), and thus may be able to perform the measurement without the use of an additional measuring device (403), and directly communicate the measurements to the bid server (303).

The customer criteria (103) are generally used to search the normalized data (101) for matching results. Where normalized data (101) has been stored (205) in a database (203), the database (203) is searched. In the system depicted in FIG. 3, a bid server (303) receives the customer criteria/data (103) over a network (305) and queries the database (203) for results based at least in part on the customer criteria/data (103). It will sometimes happen that the customer has not provided complete information. In such circumstances, the server (303) generally will search the normalized data (101) for any results that can be returned based on the data/criteria provided.

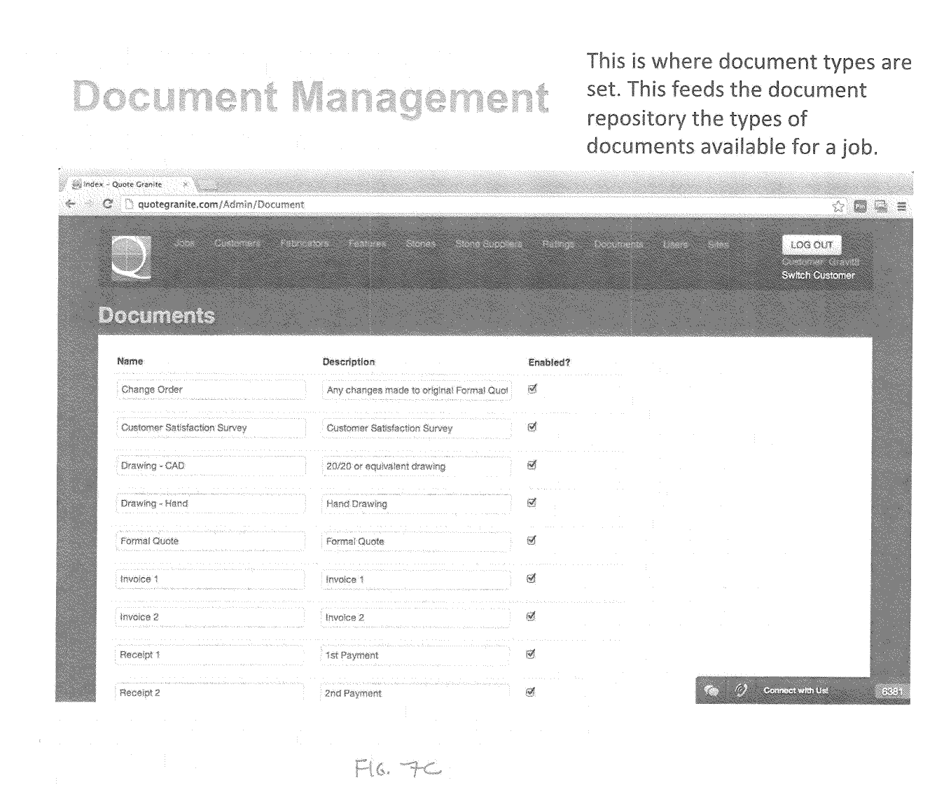

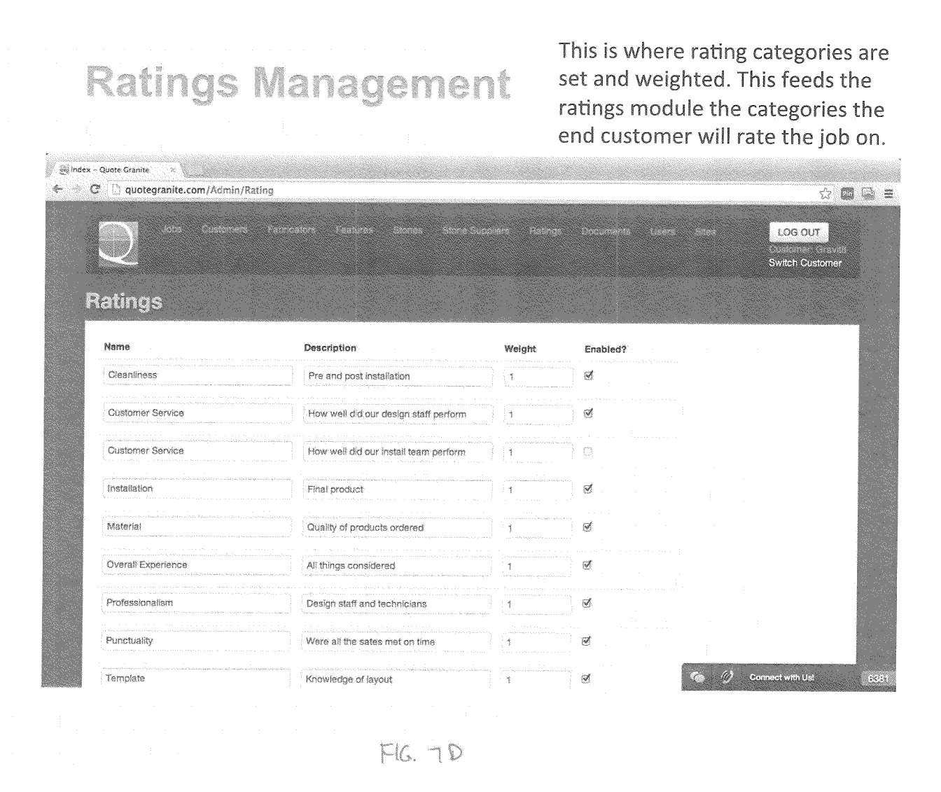

An embodiment of a form is depicted in FIG. 5. In the depicted embodiment, the form requests information about, among other things, the dimensions of the countertop (501), the number of sinks (503) and/or range cutouts (505), and the number of electrical outlets (507). If the customer provides only the dimensions of the countertop. The server (303) will then query the database (203) for any providers whose bid model is capable of returning a bid with that little information. For example, service providers whose pricing includes a sink or range cutoff may be able to provide an estimate, even if the user omits the number of sink or cooktop cutouts required.

In an embodiment, the user is presented with an indication of how many additional bids the user would receive if additional information or broader terms were provided. By way of example and not limitation, if the user provides limited information, such as square footage alone, and receives only one bid, but there are nine more fabricators who could provide bids if the number of sink cutouts were known, a message or indication will be displayed or conveyed to the user indicating that nine more bids will be provided if the user fills in the number of sink cutouts needed. In a still further embodiment, an input form for providing that number is provided with such indication, allowing the user to immediately supply the missing information without having to navigate to the input form.

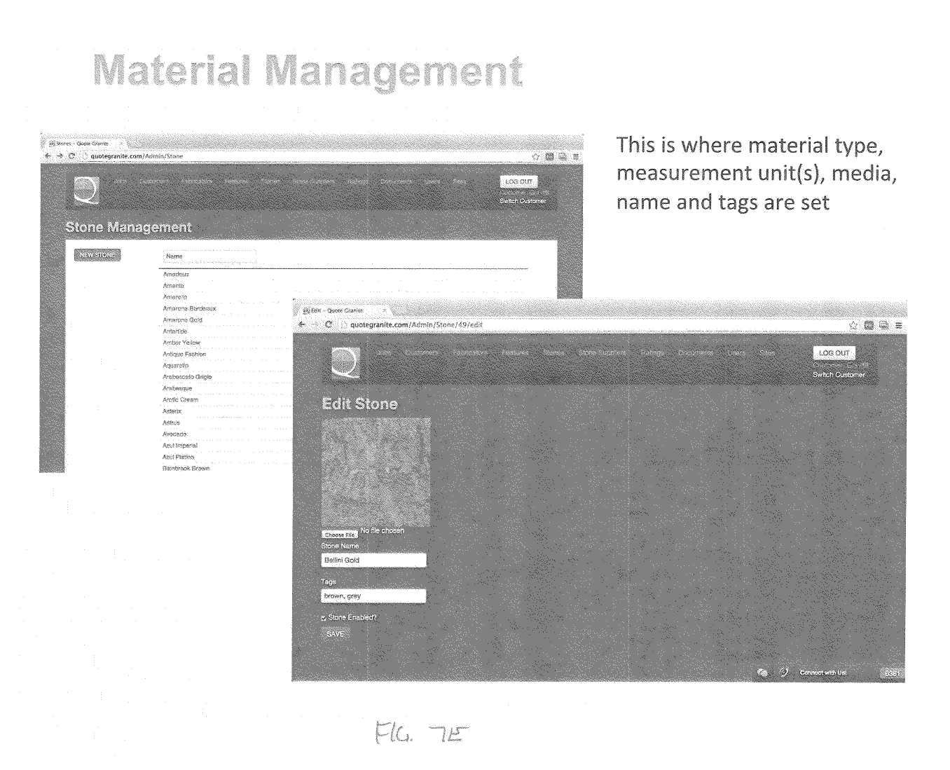

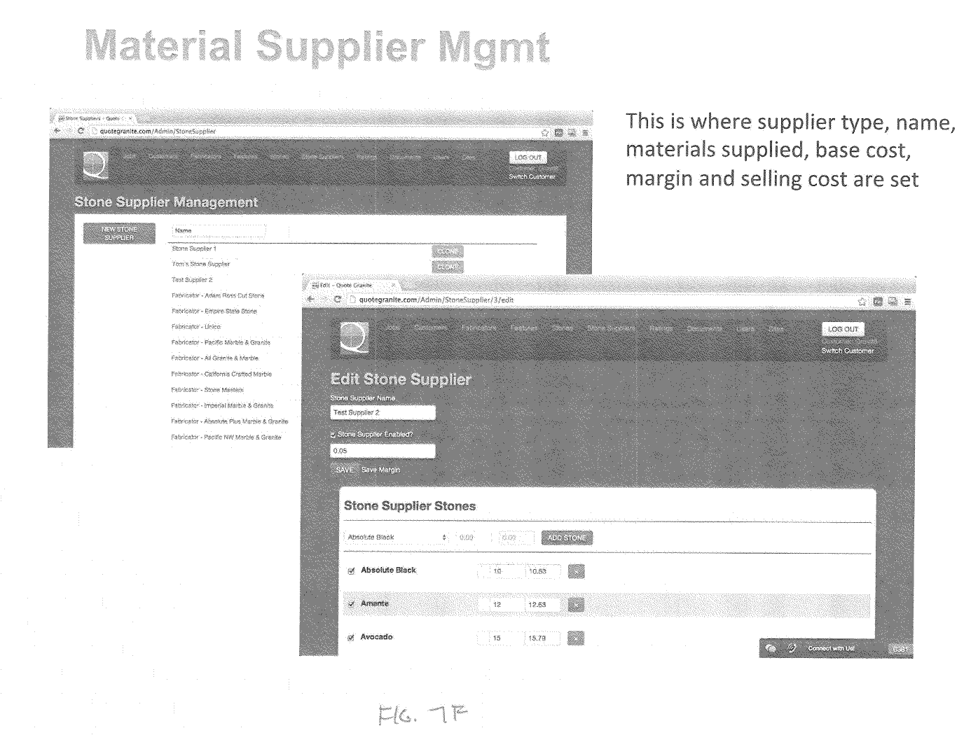

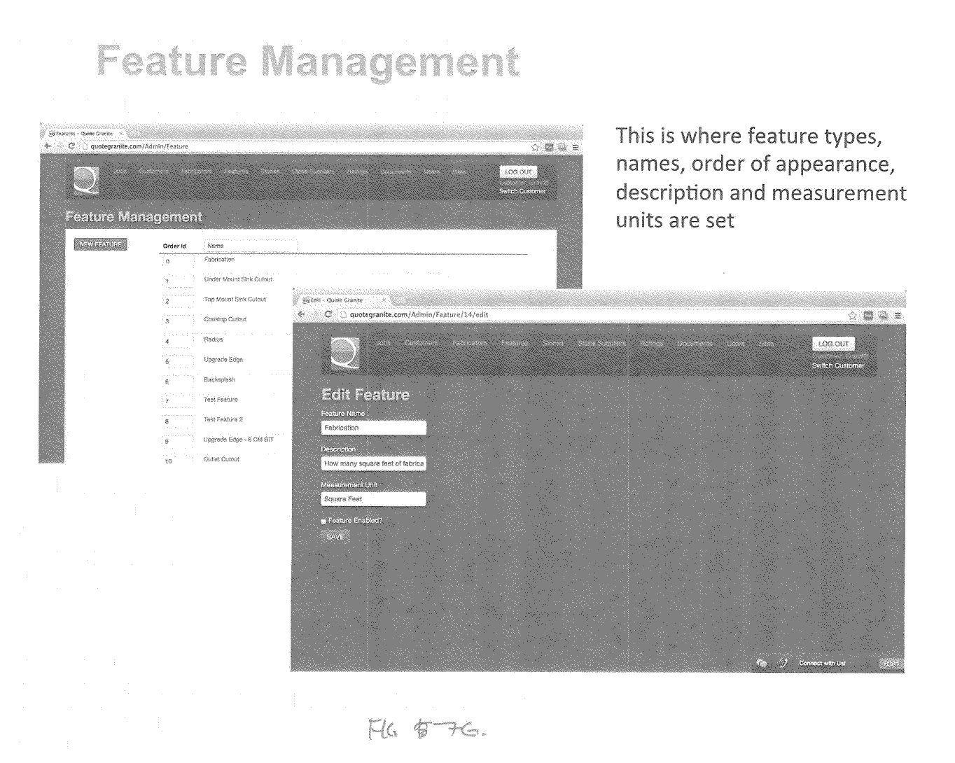

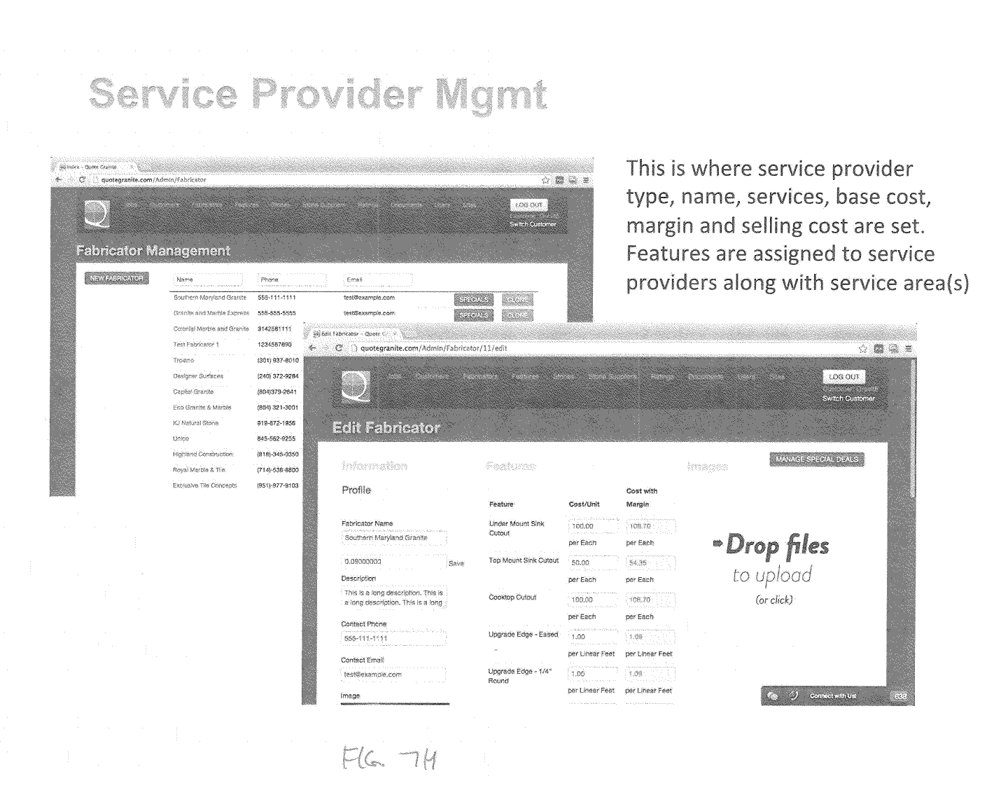

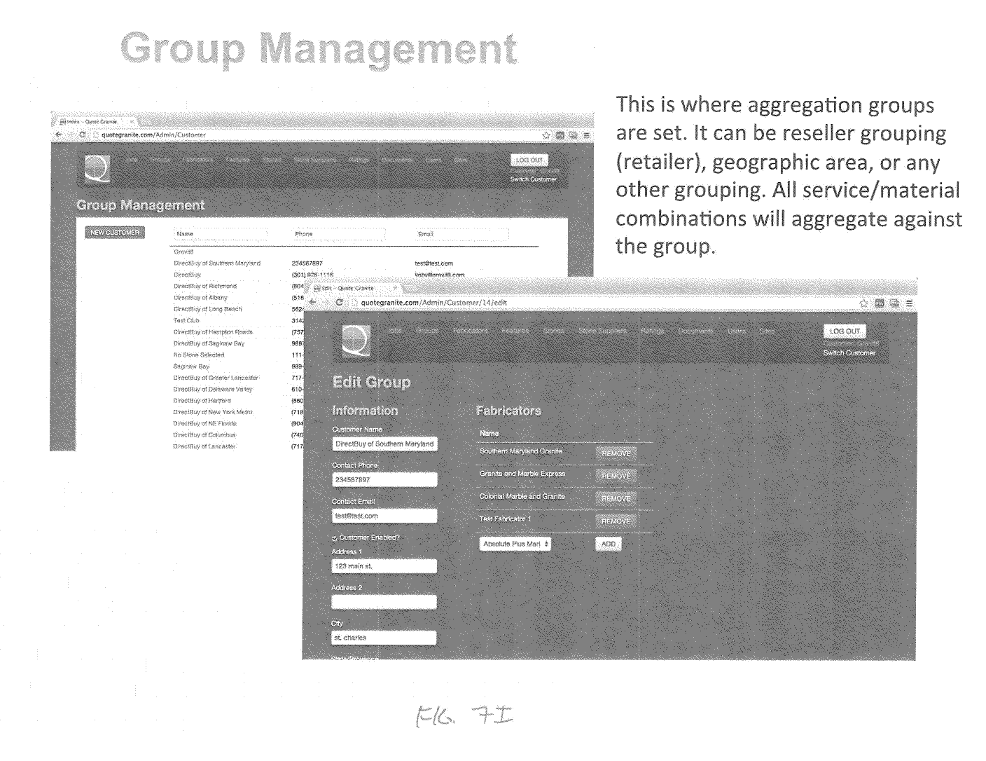

In the depicted embodiment of FIG. 3, the quote/bid server (303) receives matching results (209) from the database (203) and causes them to be comparatively displayed (107) to the user. This display is typically on a user client device (301) such as by the server (303) transmitting an indication of the data or information to be displayed to the user over the network (305). The precise content and arrangement of such display will vary with changing aesthetic tastes and evolving design principles, but generally the display will indicate the overall estimated cost (605) for each provider based upon the quote criteria and/or data supplied by the customer. An exemplary embodiment of such a display in depicted in FIG. 6. Generally, the display comprises details (601) for a selected quote (603), which details include a breakdown (607) of the features provided by the provider and the cost (609) of such features. If a given feature is included in the price, this may also be indicated (611).

Quotes are generally provided in real-time and may require calculations to generate the final quote. These calculations may differ from one provider to another but will generally be based at least in part on data provided by providers and/or normalized data. By way of example and not limitation, Provider A charges $100 per square foot including material, one undermount sink cutout, and one cooktop cutout, and charges $50 per outlet cutout. Demolition and removal of existing countertop is included. Provider B charges $50 per square foot but materials are extra at cost, sinks and cooktops are $250 apiece, and outlets are $100 apiece. Demolition and removal of existing countertop is $100. Provider C charges $3,500 for a complete countertop demolition and replacement including all features requested, provided the customer orders a product that Provider C carries. The user requests bids for a granite material pattern known as Blue Pearl, with one sink, no cooktop, demolition, and 6 power outlets. The user provides that the total counter space is 44 square feet.

In this illustrative example, the server (303) and/or database (203) perform several calculations. For Provider A, the square footage is calculated as $4400, inclusive of a sink and demolition, plus $300 for power outlets, for a total of $4,700. For Provider B, the square footage is calculated as $2200, plus $250 for a sink, $100 for demolition, and $600 for outlets, and Provider B buys Blue Pearl for $35 per square foot, for a total of $4,690. For Provider C, the cost is simply $3,500, except that Blue Pearl is not among the materials that Provider C carries, so no bid is calculated or shown for Provider C, as Provider C does not match the customer data or criteria. As described elsewhere herein, an indication may be displayed to the user indicating that if the user selects additional materials, such as material provided by Provider C's supplier, an additional quote will be available. The user may also be presented with the option to include such additional materials (without having to go back and manually select them) in the search criteria so that Provider C's bid may be included.

In this illustrative example, the two bids from Provider A and Provider B are comparatively displayed or caused to be comparatively displayed to the user by transmitting information indicative of the information to be displayed back to the user over the network. As described elsewhere herein, the information is typically displayed on a client device in an appropriate manner for the size, shape, dimensions, and resolution of such device. The user is thus able to understand the components of each bid and to alter the bid criteria to taste. For example, Provider A includes a cooktop in the price, but the user doesn't have a cooktop. For about the same price as Provider B, Provider A actually provides more total features. Thus, the customer is comparing the two providers, who price and structure their goods and services on unequal terms, in an equal “apples-to-apples” manner so that the customer can tell exactly what services/features are included in the price, and which are not.

In a further embodiment, a bid or quote may be modified to include information not requested by the user to ensure an apples-to-apples, or equal comparison. A warning or indication may be provided to the user indicating this change. In the above illustrative example, although the bids might be perceived as “equal” to the extent they are both bids for the scope of the work requested by the user, the scope of services included in the prices is not actually the same because Provider A's price assumes a cooktop cutout (which the user does not need) but Provider B's does not. In an embodiment, an indication may be provided to the user that Provider A's scope of services includes features not needed or requested by the user. In another embodiment, the quote for Provider B may be modified to include a cooktop cutout so that the quotes provided are not only for the same project (user's countertop) but for the same scope of services/features.

The quote criteria provided by the user may include the use of descriptive hashes and/or search by material. This is a major improvement over existing solutions, as there is currently no simple or fast way for a customer to compare the quotes among providers who can install a given material. For example, if the user has found the type of wood flooring the user wishes to have installed, the user can get bids for all installers who install that specific material.

The display (107) may also include feedback or ratings for each installer. In an embodiment, the rating may be a number in a range, such as “⅗,” or may be visually depicted as one or more symbols or tokens or a portion thereof (613). In the depicted embodiment of FIG. 6, ratings are depicted as a number of “stars” (613). These community ratings are provided by other customers who have previously used the provider and provided feedback ratings. Ratings are discussed in more detail elsewhere herein.

One advantage of the systems and methods is that providers may worry less about arithmetic errors, transposed numbers, or other overlooked elements of the bid, all of which can contribute to inaccurate bids that are either too high (costing sales) or too low (costing profits), because the provider has already supplied the information the provider knows in advance will be needed for a bid. Once the customer provides the additional information needed for a specific project, the bid can be automatically or programmatically calculated. This is also appealing to the provider because it removes last minute haggling for “freebies,” which can draw out project timelines and reduce productivity with unprofitable busywork. The customer has the certainty of a documented price and feature set, and the security that the customer was able to competitively shop bids and get the customer's desired mixture of price and quality, without making a decision under pressure with a provider standing in the kitchen.

In further embodiments, the systems and methods may comprise additional steps and features. By way of example and not limitation, the depicted embodiment of FIG. 2 further comprises a documentation module. Once the user selects (211) a winning bid, documentation may be automatically generated to form the contract. This documentation may also be stored (213) in a database (203) so that both the provider and the customer always have access to it for reference. The use of robust and complete documentation containing the terms of the bid clarifies project scope, reduces arguing, and improves efficiency. Documents which may be tracked include, but are not necessarily limited to: bids, acceptance, change orders, change order acceptance, bid change, material order, service order, material receipt, proof of insurance, proof of bond, proof of certification, business licenses, union papers, project completion certificates, notice of deliverable, acceptance forms, and lien waivers.

In a still further embodiment, the systems and methods may comprise a scheduling module. By way of example and not limitation, in the depicted embodiment of FIG. 2, project work can be scheduled and the job performed (215). Again, this is generally done by the user manipulating a user interface on a device (301) to indicate the user's acceptance of the desired bid. The user can scan and upload signed documents, including e-signed documents, accepting the estimate and use an interface to schedule a start time or initial consultation time to meet with the provider and conduct an initial inspection. This may be done, for example, through a calendar interface which only permits the provider's available times to be selected for scheduling. The system may track scheduled events through a database (203).

In a still further embodiment, the system comprises a payment processing module (not depicted). Such a module may provide, transmit, and/or display invoices, receipts, and/or a payment gateway and/or processing system. In such an embodiment, payments may be made automatically, such as by providing a payment card or bank account information and authorizing charges and/or deductions to be made according to the schedule and/or time table for the project.

The systems and methods generally comprise a review/rating module. Such a module generally facilitates the submission of numeric ratings, and narrative reviews, of a given provider. These ratings may be provided for a plurality of performance metrics, such as quality, timeliness, professionalism, cleanliness, and intangibles. These metrics may then be aggregated for a provider into numeric ratings, both within a performance metric and across all metrics, and comparably displayed (107) in connection with quotes. This provides customers with more information about suppliers that may fill gaps in pricing. For example, if Supplier A is substantially cheaper than Supplier B, all else being equal, the reviews help customers determine whether Supplier A simply does lower quality work.

In certain embodiments, a long-term hindsight review (221) is included whereby users may submit a review, which may be a second review, only after a certain minimal amount of time has elapsed since the project end date. This minimum may be any appropriate amount of time, but will generally be at least six months and possibly a year or more in certain embodiments. This “hindsight” review feature allows users to live with the completed improvements for some time and discover any flaws, and learn how well the work and materials hold up to wear and tear.

It is common with home improvement that the brand new materials look so much different, and better, than the prior state of the home that the customer is blind to the flaws. By only permitting hindsight reviews after some minimum amount of time has passed, the temporary euphoria of a recently completed project has passed and the customer has more time to get familiar with flaws and deficiencies. Thus, in certain embodiments, the “hindsight” review is comparatively displayed alongside the standard review, allowing users to quickly assess how well a given provider's work stands the test of time. If a certain supplier has high initial ratings but low hindsight ratings, it may suggest that the supplier obscures shoddy work. As with the other modules, hindsight review provides rating and review data (223) to the database. Although the review/rating data (225) is not quote data (201), it is nevertheless one of the datasets generally selected (105) from the database (203) for display (107) to the customer.

In an embodiment, notifications are sent to one or more providers. By way of example and not limitation, where the user selects (211) a winning bid, the system may instruct the user to provide certain additional documents which will allow the provider to finalize the quote/estimate and confirm that it is accurate and acceptable. The system may also notify the provider, for example, by sending an e-mail to a pre-defined e-mail address, that a quote has been accepted so that the provider can follow up with the customer to complete the process. Likewise, when users upload or provide documents (213, 217), the provider can review the documents for completeness and/or accuracy, and may also provide documents back to the user through the system.

An aspect of the systems and methods is that quotes may be provided for all available materials and/or features across all available providers and material suppliers for a particular group. This may be so, even though a particular material supplier and provider may have no relationship, because a given service provider may nevertheless be able to acquire the material through the supplier and use it on the project. By way of example and not limitation, material suppliers may be matched with service providers whether or not a formal relationship exists between the provider and supplier. This includes, for example, where the database content does not comprise an association between a supplier profile and a provider profile.

This feature facilitates, among other things, relationship building between material suppliers and service providers, in that a customer may select a winning provider to install a material provided by a material supplier with which the service provider has not previously worked. This benefits suppliers by expanding the range of providers who are aware of and have experience installing materials supplied by that supplier, and it benefits providers by expanding the range of suppliers with whom the provider has a relationship, and materials the provider has experience installing. This benefit is particularly applicable to foreign suppliers, who may be attempting to break into new geographic territories.

This also benefits the customer in that the combinations of providers, suppliers, and materials may not be limited. By way of example and not limitation, the customer may receive multiple bids for a project using the same material, but different bids may assume that the material is acquired through a plurality of material suppliers. This facilitates an open marketplace where customers are not confined to a limited range of options based on the pre-existing relationships between providers and suppliers.

Another aspect of the systems and methods is the ability to “snapshot” a bid or quote. It is common in projects that scope or other changes may be made. By way of example and not limitation, the initial quote may reveal issues not provided by the customer, or construction may reveal additional problems with the work site that must be addressed. Where changes to the quote are made, a “snapshot” of the set of data records in the database pertaining to and describing the estimate prior to such a change is taken, the snapshot comprising a sufficient copy or subset of such data such that the quote can be reconstructed and displayed prior to the change. This “snapshot” dataset is preserved, allowing a user to view the timeline or history of changes to the project. This feature facilitates simpler dispute resolution by providing uniform historical information to all parties.

Another aspect of the systems and methods is the ability for an imaging device to capture an impression or image of materials and/or uniquely identify a particular piece of material. The imaging device is typically, but not necessarily, a digital camera. This feature would be used, for example, where the raw material is unique. By way of example and not limitation, while granite countertops are selected by pattern, natural granite is inherently unique, and each raw slab contains distinct patterns, colors, inclusions, and features. Customers purchasing granite countertops typically physically visit a warehouse to inspect a plurality of slabs and pick the specific slab the customer wishes to have fabricated into a counter top. It is specifically contemplated an imaging device may be used to capture an image of the slab and/or a unique identifier for or attached to the slab, such as a serial number, bar code, or QR code. This reduces mix-ups in material selection, which can be very costly and difficult to mitigate. As with other features, the captured data may be supplied to and stored in the database for later retrieval and transmission and/or display to the user and/or a provider.

Exemplary screenshots of an embodiment of some features of these modules are provided in Appendix A, the entire disclosure of which is included herewith and incorporated herein by reference.

While the invention has been disclosed in connection with certain preferred embodiments, this should not be taken as a limitation to all of the provided details. Modifications and variations of the described embodiments may be made without departing from the spirit and scope of the invention, and other embodiments should be understood to be encompassed in the present disclosure as would be understood by those of ordinary skill in the art.

1. A method for comparatively displaying quotes comprising:
providing a database;
providing a quote server communicatively connected to a client device over a network, said quote server comprising a microprocessor and a non-volatile computer-readable medium having computer readable instructions stored thereon, said computer-readable instructions comprising a quote module;
storing normalized quote metric data in said database;
said quote server receiving from said client device over said network a customer project criteria dataset comprising at least one measurement of a dimension for a home improvement project and an indication of at least one material to be used in a home improvement project, the amount of said material to be used in said home improvement project being based at least in part on said at least one measurement of a dimension;
said quote module selecting from said stored normalized quote metric a search result dataset, the selection of said search result database being based at least in part on said received customer project criteria dataset and comprising data indicative of a plurality of service providers, each service provider in said plurality of service providers being associated in said stored normalized quote metric data with said material;
for each one of said service providers in said plurality of service providers, said quote module calculating a bid estimate for said service provider to install said material in said home improvement project, said calculated bid estimate being based at least in part on a cost of said material indicated in said stored normalized dataset for said service provider, and said calculated bid estimate being based at least in part on said measurement of a dimension received by said quote server;
said quote server transmitting data to said client device, said transmitted data causing to be displayed on said client device, for each one of said service providers in said plurality of service providers, an identification of said service provider indicated in said stored normalized dataset and said calculated bid estimate for said service provider.

2. The method of claim 1, wherein said quote metric data is selected from the group consisting of: material data, feature data, supplier data, service provider data, and group data.

3. The method of claim 1, wherein said client device is selected from the group consisting of: a smart phone, a tablet computer, a desktop computer, a laptop computer, an e-reader, and a kiosk.

4. The method of claim 1, wherein said calculated bid estimate comprises a labor cost, a material cost, and a feature cost.

5. The method of claim 1, wherein for each service provider in said plurality of service providers, said selected search result data comprises review and rating data about said service provider.

6. The method of claim 5, wherein said transmitted data to said client device further causes to be displayed on said client device, for each one of said service providers in said plurality of service providers, a visualization of said search result data about said service provider.

7. A system for transmitting service provider quotes comprising:
a database stored on a non-volatile computer-readable storage medium, said database comprising normalized quote metric data;
a computer server communicating over a network, said server comprising a microprocessor and a non-volatile computer-readable storage medium having stored thereon computer-readable program instructions which, when executed by said microprocessor, cause said microprocessor to cause to be transmitted from said computer server to a client device communicatively connected to said server over said network a service provider dataset comprising a plurality of service provider datasets, said service provider dataset based at least in part upon normalized quote metric data selected from said database by said computer server, and said selected normalized quote metric data being selected at least in part based on customer project criteria data received by said server from said client device over said network.

8. The system of claim 7, wherein at least some of said normalized quote metric data in said database is selected from the group consisting of: material data, feature data, supplier data, service provider data, and group data.

9. The system of claim 7, wherein said client device is selected from the group consisting of: a smart phone, a tablet computer, a desktop computer, a laptop computer, an e-reader, and a kiosk.

10. The system of claim 7, wherein for each service provider dataset in said plurality of service provider datasets, said service provider dataset further comprises a programmatically calculated bid estimate for said service provider to perform a scope of services indicated by said customer project criteria received by said server.

11. The system of claim 7, wherein for each service provider dataset in said plurality of service provider datasets, said service provider dataset further comprises a review and rating data about said service provider.

12. The method of claim 11, wherein said review and rating data about said service provider is based at least in part on reviews and ratings about said service provider previously submitted by customers of said service provider.

13. A kiosk comprising:
a kiosk frame;
a display;
a manual user interface;
a client computer comprising a microprocessor and a non-volatile computer-readable memory having stored thereon computer-readable instructions which, when executed by said microprocessor, cause said client computer to:
display on said display a graphical user interface comprising a form for submitting customer project criteria data;
in response to a user submitting customer project criteria data using said form, transmit said customer project criteria data to a quote server and to request from said quote server one or more estimates for the cost of a service provider to complete the project described by the customer project criteria data;
in response to receiving from said quote server said one or more estimates, for each one of said estimates in said plurality of estimates, displaying on said display an identification of said service provider and the amount of said estimate.
